(19) United States
(12) Patent Application Publication
(10) Pub. No.: US 2007/0136985 A1
(43) Pub. Date: Jun. 21, 2007

(54) Shower curtain ring assembly

(76) Inventor: Raymond Prabhakar, Greensboro, NC (US)

Correspondence Address: Raymond Prabhakar, 4226 Pleasant Garden Road, Greensboro, NC, 27406, US

(21) Appl. No.: 11/311,112

(22) Filed: Dec. 19, 2005

(51) Int. Cl. E05D 15/00

(52) U.S. Cl. 16/87.2

(57) ABSTRACT

A shower curtain ring assembly, which is easy to open and close for easy access to a shower curtain and liner, which contains semi circular right and left ring members attached by a pivot pin through pivot pinholes at the top of each ring member. The ring members engage to magnets embedded within the bottom of ring members within a collar that prevents disengagement.

### (1) FIELD OF THE INVENTION

The present invention relates generally to a shower curtain ring assembly which includes the ability to easily attach or detach a shower curtain and a shower curtain liner. Shower curtain rings and hooks, which are utilized to hang shower curtains and shower curtain liners in a shower stall, are well known in the art. Hooks and rings are normally used to hang shower curtains to the shower enclosure. The hooks and rings tend to be cumbersome to install. Shower curtain liners and shower curtains are difficult to install and remove from rings and hooks, thereby making it difficult to change shower curtains for decorative purposes.

### (2) DESCRIPTION OF THE PRIOR ART

Thus, there remains a need for a shower curtain assembly which permits easy installation and removal of shower curtains and shower curtain liners.

### SUMMARY OF INVENTION

The present invention is directed to a shower curtain ring assembly, which is easy to open and close. The assembly comprises a semi-circular right ring member, a semi-circular left ring member which attaches to the right ring member at the top of said ring members, and an opposing pair of magnets located at the bottom of the right and left ring members. The right ring member is made of molded plastic and is no less than 5/16 inches in diameter. The right ring member further includes a collar located at the bottom of right ring member and the collar is no longer than ¾ of an inch with an outside diameter of 7/16 inches and an inside of 5/16 inches. The right ring member further includes a magnet embedded in the bottom of the right ring member and the magnet is glued in place with a water resistant glue into a recess molded into the right ring member. The right ring member further includes a male fitting at the top of the right ring member and a pivot pinhole at the top of the right ring member.

The left ring member is made of molded plastic and is no less than 5/16 inches in diameter. The left ring member further includes a magnet embedded in the bottom of the left ring member and the magnet is glued with a water resistant glue into a recess molded into the left ring member. The left ring member further includes a female fitting at the top of the right ring member and a pivot pinhole. The right and left ring members are attached at the top through complimentary pinholes by a pivot pin. The pivot pin is made from the group consisting of metal or plastic. The pivot pin permits opening and closing of the right ring member. The opposing pair of magnets, in the right and left ring members, adheres to each other when the right and left ring members are in a closed position. When the right and left ring members are in a closed position, the distance between the right and left ring members is not less than 2 inches.

The shower curtain ring assembly may further include slip on sleeves. The slip-on sleeves are made of a flexible plastic and are made in a plurality of colors. The sleeves include a right ring sleeve and a left ring sleeve, which are slipped over the right ring member and the left ring member of the shower curtain ring assembly.

The shower curtain ring assembly may further include a decorative plate assembly. The decorative plate assembly is comprised of a decorative plate, which can be attached to the shower curtain ring assembly, a clip, and a clip support piece. The decorative plate may be made from a group of materials consisting of plastic, glass, metal or wood.

One aspect of the present invention is to provide a shower curtain ring assembly, which provides easy attachment and detachment of a shower curtain liner for cleaning purposes without removing the entire assembly from the shower enclosure. Another aspect of the invention is to permit the assembly's user to easily change colors or designs of the shower curtain for aesthetic purposes.

These and other aspects of the present invention will become apparent to those skilled in the art after a reading of the following description of the preferred embodiment when considered with the drawings.

### BRIEF DESCRIPTION OF THE DRAWINGS

FIG. 1 is a frontal view of the preferred embodiment according to the present invention;

FIG. 1A is a top view of the right and left ring members;

FIG. 2 is a frontal view depicting the shower curtain ring assembly in an open position;

FIG. 3 is a frontal view depicting the shower curtain ring assembly with the collar detached;

FIG. 4A is a frontal view depicting the right and left ring members slip on sleeves;

FIG. 4B is a frontal view depicting the shower curtain ring assembly without the slip on sleeves;

FIG. 4C is a frontal view of the shower curtain ring assembly with the slip on sleeves attached;

FIG. 5A is a back view depicting the decorative plate assembly;

FIG. 5B is a back view depicting the decorative plate;

FIG. 5C is a side view depicting the clip and clip support of the decorative plate assembly; and

FIG. 5D is a side view of the decorative plate assembly attached to a shower curtain ring assembly.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

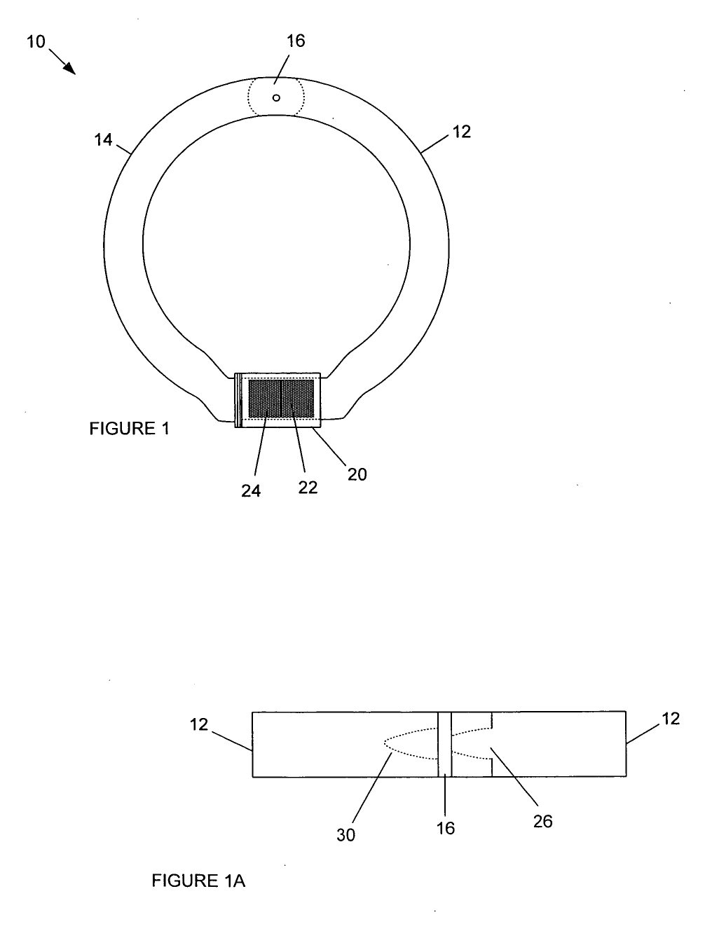

Referring now to the drawings in general and FIGS. 1 through 5D, it will be understood that the illustrations are for the purpose of describing a preferred embodiment of the invention and are not intended to limit the invention thereto. As seen in FIGS. 1 through 3, the shower curtain ring assembly 10 is comprised of a left ring member 14, a right ring member 12, a left ring member magnet 24, and a right ring magnet 22. The right ring member 12 and the left ring member 14 are semi-circular and are made of molded plastic. The diameter of the ring members 12 and 14 are no less than 5/16 inches in diameter. The right ring member 12 further includes a collar 20 located at the bottom of the ring member 12. The collar 20 is no longer than ¾ of an inch with an outside diameter of 7/16 inches and an inside diameter of 5/16 inches. The right ring member 12 further includes a magnet 22, which is embedded in the bottom of the right ring member 12. The left ring member 14 is also made of molded plastic and is no less than 5/16 inches in diameter. The left ring member 14 further includes a magnet 24 embedded in the bottom of the left ring member 14 and the magnet 24 is glued with a water resistant glue into a recess molded into the left ring member 24. The glue totally encases the magnets placed in the right ring member 12 or left ring member 14, thereby making them resistant to water damage. Both the left ring member 14 and the right ring member 12 include a pivot pinhole 16 at the top of the ring members 12 and 14.

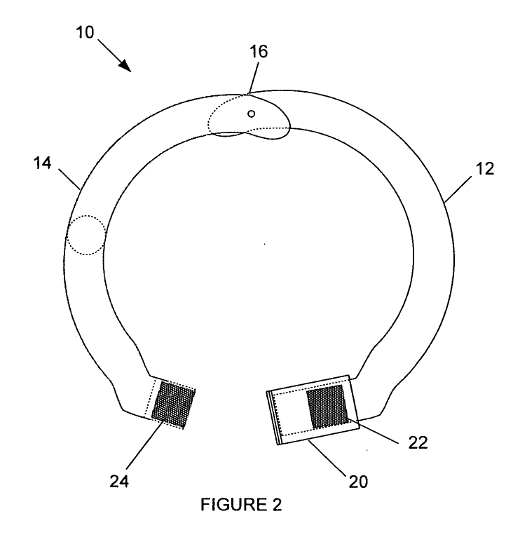

FIGS. 1 and 2 depict the shower curtain ring assembly 10 in an open and closed position. The left ring member 14 adheres with its magnet 24 to the right ring member's 12 magnet 22 within the collar 20. In the preferred embodiment, the collar 20 is molded as part of the right ring member 12. The collar 20 could however, be glued to the right ring member 12 after being separately molded.

Referring to FIG. 1A, the top of the curtain ring assembly 10 is depicted. The left ring member 14 includes a female fitting 30 molded into the top of the left ring member 14. The right ring member 12 includes a male fitting 26 molded to the top of the right ring member 12.

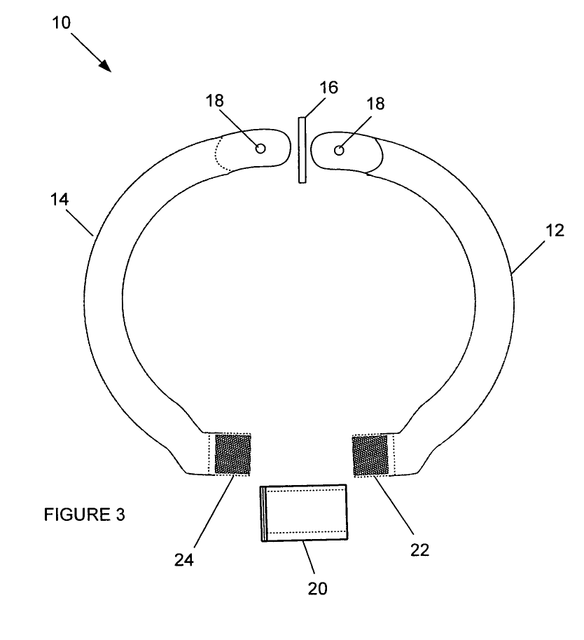

Referring to FIGS. 1, 1A and 3, a pivot pinhole 18 is depicted. The pivot pinhole 18 is in a complimentary position in the right ring member 12 and the left ring member 14. When the right ring member 12 and left ring member 14 are attached at the top, and the right ring male fitting 26 and left ring female fitting 30 are complimentary attached, a pivot pin 16 is placed in the pivot pinhole 18 to hold the right ring member 12 and the left ring member 14 together. The pivot pin 16 can be made from a group consisting of metal or plastic.

Again, referring to FIGS. 1 through 3, the shower curtain ring assembly 10 is placed on a shower bar (not shower) with the pivot pinhole 18 resting on the top of the shower curtain bar. The shower curtain ring assembly 10 is in an open position, and the shower curtain and shower curtain liner (not shown) are placed over the collar 20.

A sufficient number of shower curtain assemblies 10 should be utilized to match each hole in a shower curtain and shower curtain liner (not shown). After the shower curtain and shower curtain liner (not shown) are attached to a sufficient number of shower curtain assemblies 10, so that each opening hole in the shower curtain and shower curtain liner (not shown) are filled with shower curtain ring assemblies 10, the shower curtain ring assemblies 10 are closed and the right ring magnets 22 are engaged to the left ring magnets 24 within the collar 20 of each ring assembly. The collar 20 is designed to carry the weight of the affixed shower curtain and shower curtain liner (not shown). The collar 20 distributes the weight of the shower curtain and shower curtain liner (not shown) over the width of the collar 20. The collar 20 further prevents the left ring magnet 24 and the right ring member 22 from disengaging because of the weight of the affixed shower curtain and shower curtain liner (not shown).

In the preferred embodiment, the shower curtain ring assembly 10 is made of molded plastic, however, it may be made of metal, wood, glass or any other substance desired for decorative and aesthetic purposes. The shower curtain ring assemblies 10 of the preferred embodiment permits the shower curtain and shower curtain liner (not shown) to be easily attached to the bar and to be easily removed from the ring assembly 10. Consequently, changing shower curtains for decorative purposes is facilitated by ease in which they can be placed on or off the shower ring assembly 10. The shower curtain (not shown) may be left on the ring assembly 10 and the shower curtain liner may be easily removed for cleaning or replacement.

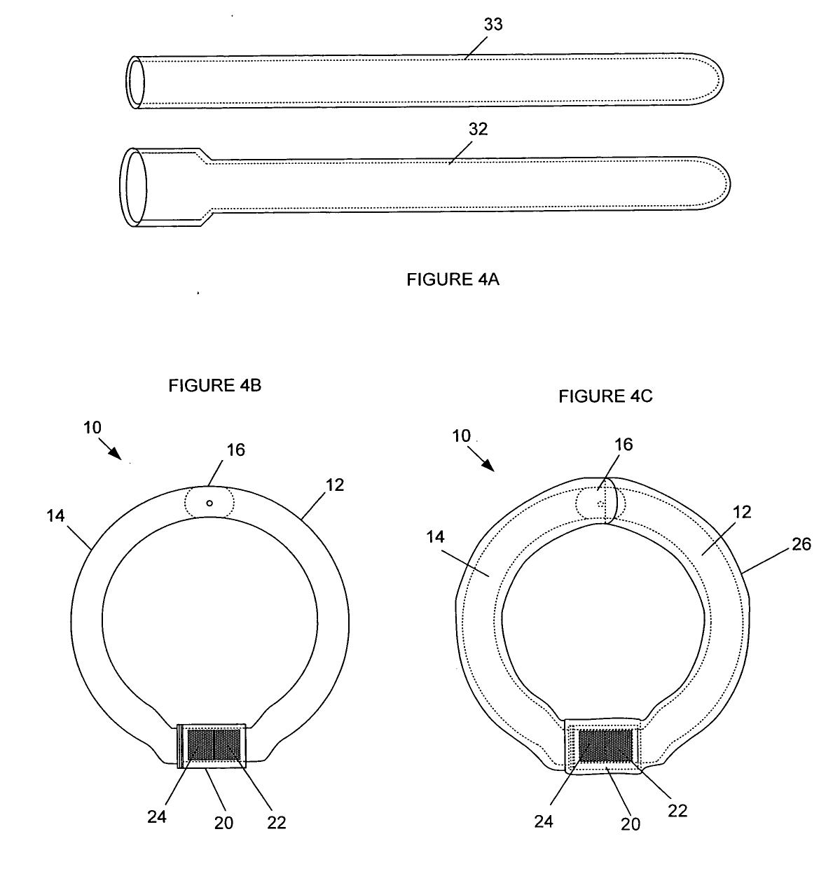

Referring to FIGS. 4A through 4C, the slip on sleeve is depicted. The slip on sleeves 32 and 33 are made of flexible plastic and are made in plurality of different colors or designs. The left ring sleeve 33 is affixed to the left ring member 14. The right ring sleeve 32 is affixed to the right ring member 12. The right ring sleeve 32 has an enlarged portion at one end to accommodate the increased size of the collar 20. Use of the slip on sleeves 32 and 33 permit user to change colors or designs of the shower ring curtain assembly 10, so that when the user changes the color or décor of the shower curtain (not shown) replacement and or addition of slip on sleeves 32, 33 will provide the necessary match with a replacement shower curtain (not shown).

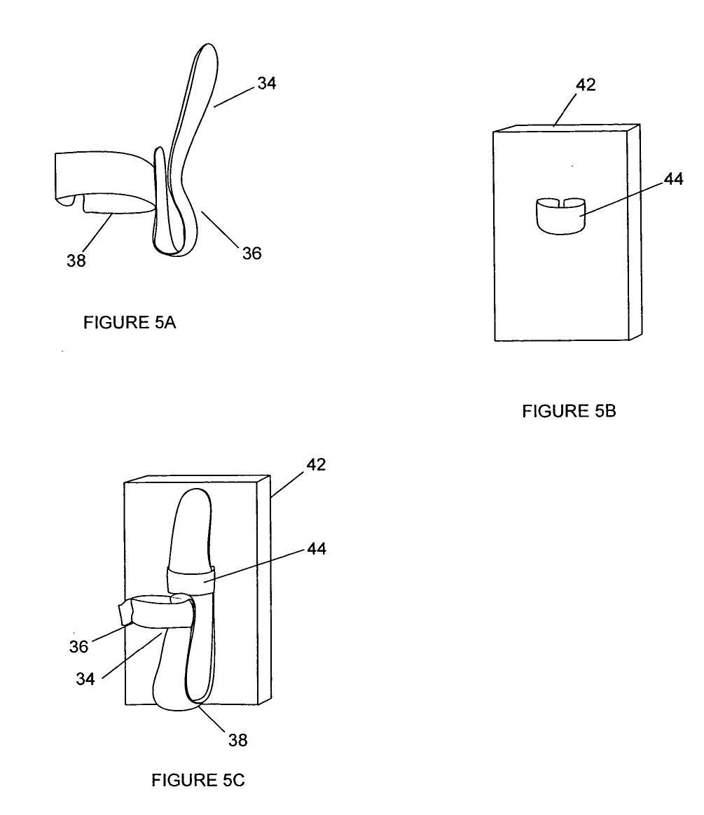

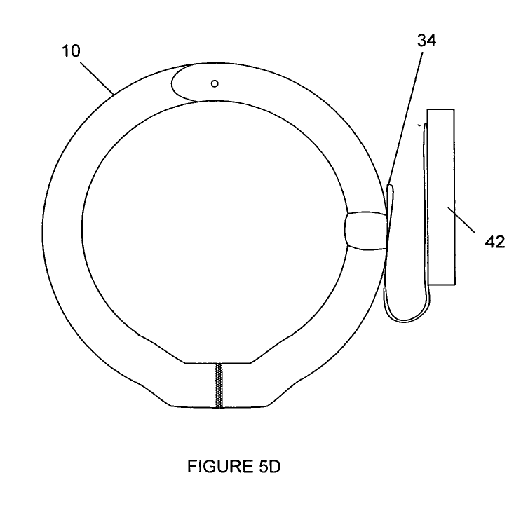

The shower curtain assembly 10 may further include a decorative plate assembly 42. Referring to FIGS. 5A through 5D, the decorative plate assembly 42 is comprised of a decorative plate 42, a clip 38, a clip support 36, and a decorative plate holding bracket 44. The decorative plate 42 may be made from a group of materials including plastic, glass, metal or wood. The decorative plate 42 may be made in different sizes and shapes and have various decorative themes. The decorative plate 42 further includes the decorative plate holding bracket 44, which is the rectangular unshaped bracket affixed to the rear of the decorative plate 42. The decorative plate holding bracket 44 may be glued, or welded to the decorative plate 42 or molded as part of the decorative plate 42 if the decorative plate 42 is a molded piece The clip 38 and the clip support 36 are made from molded plastic. The clip 38 and clip support 36 may be molded in one piece together, or the clip 38 and the clip support 36 may be glued together.

Referring to FIG. 5D, the decorative plate assembly 42 is depicted as attached to the shower curtain ring assembly 10. The clip portion 38 fits around either the left or right ring members 12, 14, and adheres to the member by tension. The clip 38 is a tension, molded clip, which snaps onto the right ring members 12 or left ring members 14 of the shower curtain ring assemblies 10. The decorative plate 42 permits the user of the shower curtain ring assembly 10 to change themes for holidays or other events by use of an appropriate themed decorative plate 42.

Certain modifications and improvements will occur to those skilled in the art upon a reading of the foregoing description. By way of example, the pivot mechanism may be molded into the right ring member 12 and left ring member 14. The right ring member 12 and left ring member 14 may be joined at the top with a snap lock device molded into the respective members. It should be understood that all such modifications and improvements have been deleted herein for the sake of conciseness and readability but are properly within the scope of the following claims.

What is claimed is:

1. A shower curtain ring assembly, which is easy to open comprising:
a semi circular right ring member;
a semi circular left ring member, which attaches to the right ring member at the top of said ring members; and
an opposing pair of magnets located in the bottom of the right and left ring members.

2. The apparatus according to claim 1, wherein the right ring member is made of molded plastic.

3. The apparatus according to claim 2, wherein said right ring member is no less than 5/16 inches in diameter.

4. The apparatus according to claim 2, wherein said right ring member further includes a collar located at the bottom of the right ring member.

5. The apparatus according to claim 4, wherein said collar is no longer than ¾ inches with an outside diameter of 7/16 inches and an inside diameter of 5/16 inches.

6. The apparatus according to claim 2, wherein said right ring member further includes a magnet embedded in the bottom of said right ring member.

7. The apparatus according to claim 6, wherein said magnet is glued with a water resistant glue into a recess molded into a right ring member.

8. The apparatus according to claim 2, wherein said right ring member further includes a male fitting end at the top of said right ring member.

9. The apparatus according to claim 2, wherein said right ring member further includes a pivot pinhole at the top of said right ring member.

10. The apparatus according to claim 1, wherein left ring member is made of molded plastic.

11. The apparatus according to claim 10, wherein said left ring member is no less than 5/16 inches in diameter.

12. The apparatus according to claim 10, wherein said left ring member further includes a magnet embedded in the bottom of said left ring member.

13. The apparatus according to claim 12, wherein said magnet is glued with a water resistant glue into a recess molded into a left ring member.

14. The apparatus according to claim 10, wherein said left ring member further includes a female fitting end at the top of said left ring member.

15. The apparatus according to claim 10, wherein said left ring member further includes a pivot pinhole at the top of said left ring member.

16. The apparatus according to claim 1, wherein the right and left ring members are attached at the top through complimentary pinholes by a pivot pin.

17. The apparatus according to claim 16, wherein said pivot pin is made from the group consisting of metal or plastic.

18. The apparatus according to claim 16, wherein said pivot pin permits opening and closing of a right and left ring member.

19. The apparatus according to claim 1, wherein said opposing pair of magnets in the right and left ring members adhere to each other when the right and left ring members are in a closed position.

20. The apparatus according to claim 19, wherein when said right and left ring members are in a closed position the distance between the right and left ring member is not less than two inches.

21. The apparatus according to claim 1, wherein the shower curtain ring assembly further includes slip on sleeves.

22. The apparatus according to claim 21, wherein said sleeves are made from flexible plastic.

23. The apparatus according to claim 22, wherein said flexible plastic sleeves are made in a plurality of different colors.

24. The apparatus according to claim 21, wherein said sleeves include a right ring sleeve and a left ring sleeve.

25. The apparatus according to claim 234 wherein said right ring sleeve and left ring sleeve are slipped over a right ring member and a left ring member.

26. The apparatus according to claim 1, wherein the shower curtain ring assembly further includes a decorative plate assembly.

27. The apparatus according to claim 26, wherein said decorative plate assembly comprises:
a decorative plate, which can be attached to a shower curtain ring assembly;
a clip; and
a clip support piece.

28. The apparatus according to claim 27, wherein the decorative plate can be made from a group of materials consisting of plastic, glass, metal, or wood.

29. The apparatus according to claim 27, wherein said decorative plate may be made in various sizes and shapes and have varied decorative themes.

30. The apparatus according to claim 27, wherein said decorative plate further includes a clip holding bracket.

31. The apparatus according to claim 30, wherein said clip holding bracket is a rectangular unshaped bracket affixed to the rear of a decorative plate.

32. The apparatus according to claim 31, wherein said clip holding bracket may be glued/welded to a decorative plate or molded as part of the decorative plate if the decorative plate is molded.

33. The apparatus according to claim 27, wherein said clip is made from molded plastic.

34. The apparatus according to claim 33, wherein said molded clip is semicircular and clips onto a ring member of a shower curtain ring assembly by tension.

35. The apparatus according to claim 27, wherein said clip support piece is molded plastic.

36. The apparatus according to claim 35, wherein said molded plastic clip support piece is affixed to a clip.

37. The apparatus according to claim 36, wherein said clip support piece is affixed to a clip with glue or molded as part of the clip.

38. A method to install a shower curtain ring assembly comprising:
procuring a shower curtain ring assembly;
opening the right and left ring members of each ring in the set contained in the assembly;
placing the opened rings over a shower curtain bar with the closed part over the bar;
procuring a shower curtain and shower curtain liner;
affixing the shower curtain and shower curtain liner over the collar of each of the suspended rings in the shower curtain assembly set; and
closing the right and left members of each ring within the shower curtain ring assembly thereby engaging magnets in each of the right and left members.

39. The method of claim 38 may further include procuring slip on sleeves in numerous colors.

40. The method of claim 39, wherein the appropriate color slip on sleeve is selected and placed on a right and left ring member of each ring within a shower curtain ring assembly.

41. The method of claim 38 may further include procuring decorative plate assemblies in an appropriate color and theme for each ring in a shower curtain ring assembly.

42. The method of claim 41, wherein attachment of the decorative plate assemblies comprises:
affixing a clip and clip support pieces to clip holding brackets of the decorative plates; and
snapping the clips onto each ring of a shower curtain ring assembly.
